(19) United States
(12) Patent Application Publication
(10) Pub. No.: US 2007/0286960 A1
(43) Pub. Date: Dec. 13, 2007

(54) AIRLESS SPRAY NOZZLE

(75) Inventor: Deborah Kosovich, Grafton, OH (US)

Correspondence Address: CALFEE, HALTER & GRISWOLD, LLP, 800 SUPERIOR AVENUE, SUITE 1400, CLEVELAND, OH, 44114, US

(73) Assignee: NORDSON CORPORATION, Westlake, OH (US)

(21) Appl. No.: 11/778,130

(22) Filed: Jul. 16, 2007

Related U.S. Application Data
(62) Division of application No. 10/550,050, filed on Sep. 21, 2005.
(60) Provisional application No. 60/320,103, filed on Apr. 11, 2003.

(51) Int. Cl. B05D 1/02

(52) U.S. Cl. 427/421.1

(57) ABSTRACT

An airless spray nozzle tip (10) for use in coating workpieces such as containers includes a first groove (40) located on one side (24) Of the tip, and second (30), third (32) and fourth (34) grooves located on the other side of the tip, thereby forming three orifices in the nozzle tip (10). The nozzle tip (10) produces a generally circular spray pattern with a diameter of at least about one half inch, at a distance in the range of from about one inch to about three inches from the nozzle tip, and at a flow rate at or below about 0.045 gallons per minute A process of coating a workpiece, such as a container, includes spraying liquid from a nozzle tip to produce this generally circular pattern, the nozzle tip preferably having three orifices.

### BACKGROUND OF THE INVENTION

This invention relates generally to airless spray nozzles and more particularly to airless spray nozzle tips. Further, this invention relates to a method and apparatus for forming a circular spray pattern of a liquid coating material sprayed at a low flow rate at a particular distance from the nozzle tip, with the coating material being evenly distributed across the spray pattern.

Spray nozzles are used to shape and atomize liquids projected from a spray gun. Upon discharge from the spray nozzle, the liquid material breaks up into droplets and forms a spray pattern or cloud of droplets. Various spray patterns are used for different applications. One common spray pattern is a circular pattern.

Nozzles used to produce circular patterns generally take one of two forms, either using two single cut nozzle tips, or one dual cut nozzle tip. By “single cut nozzle tip” is meant that type of nozzle tip shown in Rood U.S. Pat. No. 4,346,849. As disclosed in this patent, an orifice through a nozzle tip is formed by the intersection of a first groove on the pressurized or back side of the nozzle tip with a second groove (or “cut”) on the discharge side or front side of the nozzle tip. The nozzle tip formed in this fashion produces a fan pattern. The shape and depth of the grooves determines the spray pattern width and the flow rate of the nozzle tip. Putting two of these nozzle tips side by side in a single nozzle, with the resulting fluid streams intermingling, can produce in some circumstances a generally circular spray pattern.

By “dual cut nozzle tip” is meant that type of nozzle tip shown in Stoudt U.S. Pat. No. 4,579,286. As disclosed in this patent, two orifices are formed by the intersection of a first groove on the pressurized or back side of the nozzle tip with second and third grooves (or “cuts”) on the discharge side or front side of the nozzle tip. This nozzle also can, in some circumstances, produce a generally circular pattern.

There are multiple factors that determine whether a particular nozzle tip can produce a particular spray pattern, including the viscosity of the liquid being sprayed, the size (diameter) of the pattern to be produced, at what distance from the nozzle tip, and the flow rate of the liquid being sprayed. The two prior art nozzle tips discussed above have limited usefulness in producing a generally circular pattern over different combinations of these factors. For example, when trying to produce a circular pattern with a dual cut nozzle tip, it is necessary to separate the cuts in order to produce a larger diameter pattern. However, as the cuts are moved farther apart, the two resulting fluid streams separate and do not produce the desired circular pattern.

### SUMMARY OF THE INVENTION

The present invention relates to airless spray nozzle tips and their use on coating workpieces such as containers. In one aspect, the invention relates to an airless spray nozzle tip having first and second major sides. A first groove is located on the first major side of the tip. Second, third and fourth grooves are located on the second major side of the tip, extending parallel to each other and perpendicular to the first groove. The second, third and fourth grooves penetrate the first groove, thereby forming three orifices in the nozzle tip. The nozzle tip preferably produces a generally circular pattern with a diameter of at least about one half inch, at a distance in the range of from about one inch to about three inches from the nozzle tip, and at a flow rate below about 0.045 gallons per minute.

In another aspect, the invention relates to a process of coating a workpiece with liquid sprayed from a nozzle. The process includes the steps of directing the liquid at the workpiece through a nozzle tip in the nozzle, and producing a generally circular pattern with a diameter above about one half inch, at a distance in the range of from about one inch to about three inches from the nozzle tip, and at a flow rate below about 0.045 gallons per minute.

In a further aspect, the invention relates to a airless spray nozzle tip for spraying liquid at a workpiece, the nozzle tip having first and second sides, and the nozzle tip having a plurality of orifices extending between the first and second sides for spraying the liquid at the workpiece. The nozzle produces a generally circular spray pattern with a diameter of at least about one half inch, at a distance in the range of from about one inch to about three inches from the nozzle tip, and at a flow rate below about 0.045 gallons per minute.

In yet another aspect, the invention relates to a process of coating a portion of a container with liquid sprayed from a nozzle. The process includes the steps of directing the liquid at the container through a nozzle tip in the nozzle, and producing a generally circular pattern with a diameter above about one half inch, at a distance in the range of from about one inch to about three inches from the nozzle tip, and at a flow rate below about 0.045 gallons per minute.

### BRIEF DESCRIPTION OF THE DRAWINGS

The foregoing and other features of the present invention will become apparent upon consideration of the following description of the invention with reference to the accompanying drawings, in which:

FIG. 1 is a sectional view of a nozzle and nozzle tip in accordance with one embodiment of the invention;

FIG. 2 is a perspective view of the nozzle tip of FIG. 1;

FIG. 3 is an enlarged sectional view of the nozzle tip of FIG. 1;

FIG. 4 is an illustration of a spray pattern obtained using a prior art nozzle tip;

FIG. 5 is an illustration of a spray pattern obtained using a nozzle tip as shown in FIG. 1;

FIG. 6 is an illustration of another spray pattern obtained using a nozzle tip as shown in FIG. 1;

FIG. 7 is an illustration of another spray pattern obtained using a nozzle tip as shown in FIG. 1; and

FIG. 8 is an illustration of another spray pattern obtained using a nozzle tip as shown in FIG. 1.

### DETAILED DESCRIPTION OF THE INVENTION

This invention relates generally to airless spray nozzles and more particularly to airless spray nozzle tips. Further, this invention relates to a method and apparatus for forming a circular spray pattern of a liquid coating material sprayed at a low flow rate at a particular distance from the nozzle tip, with the coating material being evenly distributed across the spray pattern. The invention is applicable to nozzle tips of differing constructions. As representative of the invention, FIG. 1 illustrates a nozzle tip 10 that is a first embodiment of the invention.

The nozzle tip 10 is supported in a nozzle body 12 to form a nozzle 20. The nozzle tip 10 is brazed to the nozzle body 12 at an annular seat 22. In use, the nozzle body 20 is connected to a source of pressurized coating material such as a spray gun (not shown). The nozzle tip 10 as shown is a cylindrical disc, preferably a sintered tungsten carbide cylindrical disc. The nozzle tip 10 has a pressurized side, or back side surface, 24 and a non-pressurized side, or front side surface 26. The disc that forms the nozzle tip 10 has a diameter of, for example, about 0.203″ and a depth of, for example, about 0.080″ between the front side 26 and the back side 24.

Orifices in the nozzle tip 10 shape the spray pattern of coating material directed from the spray gun. Three orifices are formed in the nozzle tip 10. Specifically, a first orifice 30, a second orifice 32, and a third orifice 34 extend through the nozzle tip 10. The orifices 30-34 are formed generally in the manner shown in the above-identified U.S. Pat. Nos. 4,346,849 and 4,579,286, the disclosures of which are incorporated herein by reference; that is, by a plurality of intersecting grooves. Each one of the grooves is preferably formed by a grinding wheel (not shown) having a wedge-shaped or frusto-conical cutting edge. The included angle of the cutting edge determines the slope of the side walls of the respective grooves.

In the nozzle tip 10, a first or back side groove 40 extends inwardly from the back side 24 of the nozzle tip. The first groove includes two sidewalls 42 and 44 which join together at a substantially straight edge 46. The back side groove 40 preferably extends approximately halfway through the tip 10 from the back side 24 to the non-pressurized front side 26.

A second groove 50, which is a first front side groove, is formed in the front side 26 of the nozzle tip 10. The second groove 50 has the cross-sectional configuration generally of an isosceles trapezoid. The second groove 50 includes a bottom or base 52 and two sidewalls 54 and 56. The side walls 54 and 56 extend upwardly and outwardly from the base 52. The second groove 50 extends perpendicular to the back side groove 40.

A third groove 60, which is a second front side groove, is formed in the front side 26 of the nozzle tip 10. The third groove 60 has the cross-sectional configuration generally of an isosceles trapezoid. The third groove 60 includes a bottom or base 62 and two sidewalls 64 and 66. The side walls 64 and 66 extend upwardly and outwardly from the base 62. The third groove 60 extends parallel to the second groove 50 and perpendicular to the back side groove 40.

A fourth groove 70, which is a third front side groove, is formed in the front side 26 of the nozzle tip 10. The fourth groove 70 has the cross-sectional configuration generally of an isosceles trapezoid. The fourth groove 70 includes a bottom or base 72 and two sidewalls 74 and 76. The side walls 74 and 76 extend upwardly and outwardly from the base 72. The fourth groove 70 extends parallel to the second and third grooves 50 and 60, and perpendicular to the back side groove 40.

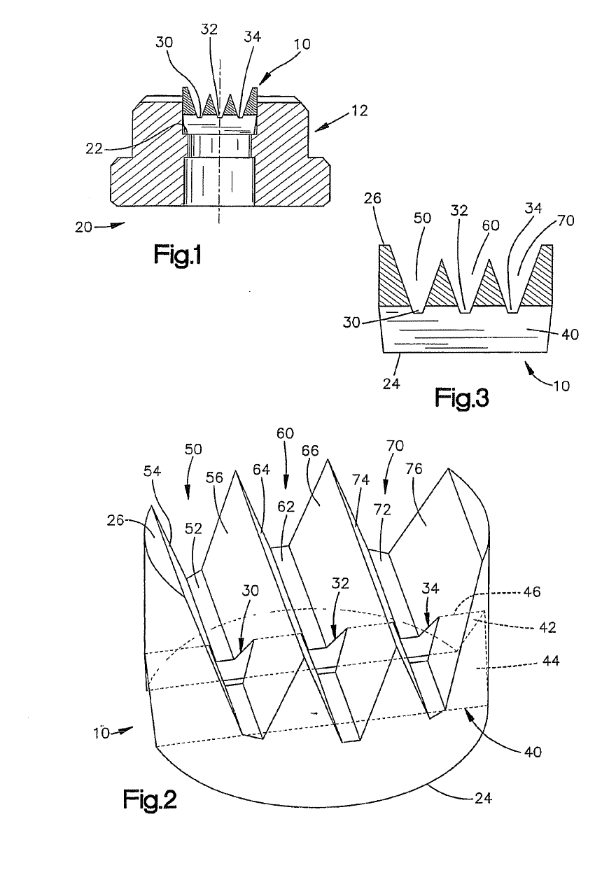

As shown in FIG. 2, to the extent that the bases 52, 62 and 72 of the front side grooves 50, 60 and 70, respectively, intersect the back side groove 40 and extend below its top edge 46, the three orifices 30-34 are created. The dimensions of the orifices 30-34 are defined by, among other factors, the included angle of the grinding wheel used to form each groove, the length (L) and width (W) of the formed orifices, and the chordal distance between the two walls of a groove at a given distance from the bottom edge or base of the groove.

The nozzle tip 10 of the present invention is designed to provide a circular spray pattern of material at a low flow rate. The flow rate of a nozzle is increased by increasing the size of the orifices through the nozzle. The size and shape of the spray pattern, however, are a function of flow rate, orifice length, and the angle of the back side groove, and the number and placement of orifices.

The nozzle tip 10 of the present invention is useful to obtain a relatively large circular spray pattern at a low flow rate with the material being evenly distributed across the spray pattern. The spray patterns formed by the three orifices 30-34 are fan-shaped streams which overlap each other and which are aligned with each other along the long axis of each spray pattern. The streams combine to form one circular spray pattern.

One application for the nozzle 20 of the present invention (of the many possible applications) is rivet repair in pull-tab can ends. For this application, a circular spray pattern is desired, ranging in size up to about one inch. This pattern is preferably obtained with the workpiece being at a distance of from about one inch to about three inches from the nozzle tip 10. The pattern is preferably obtained at a flow rate of under about 0.045 gallons per minute of spray lacquer, which may be solvent-based or water-based. Nozzle tips of the present invention could be used at flow rates as low as, for example, 0.01 gallons per minute. A higher flow rate in this application is not desired, although it may be desired for other applications, in which case nozzle tips in accordance with the present invention could be provided to produce circular spray patterns as described herein.

Using a dual cut nozzle made according to the disclosure in Stoudt U.S. Pat. No. 4,579,286, one can not reliably obtain this pattern under these spray conditions. For example, it is necessary to increase the separation between the two cuts in order to produce a larger pattern at a given distance from the nozzle tip. However, as the cuts are moved farther apart, the two fluid streams separate and do not produce the desired circular pattern.

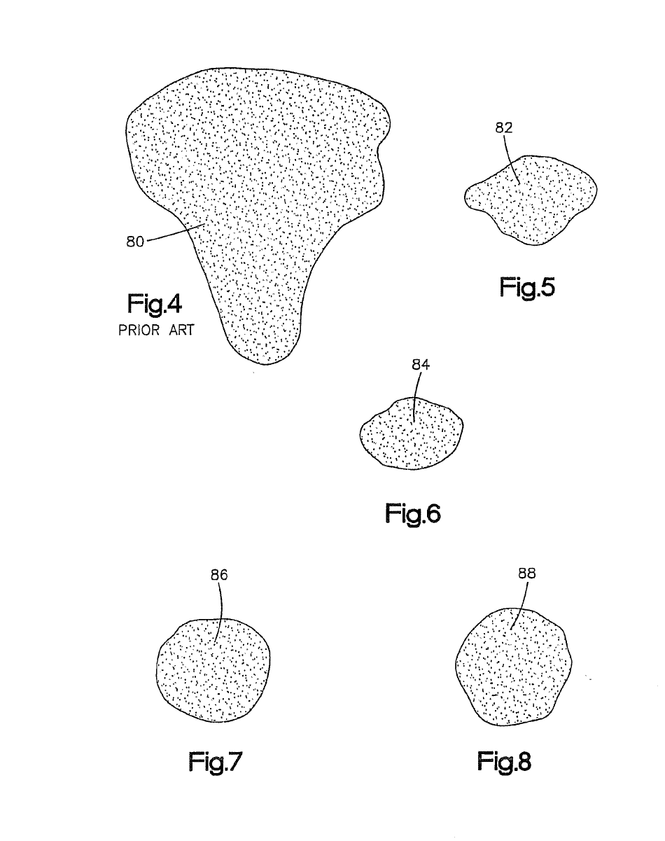

FIG. 4 illustrates the spray pattern 80 obtained from a prior art dual cut nozzle at a flow rate of 0.045 gallons per minute. The spray pattern has a pattern width (vertical dimension as shown in FIG. 4) of about 13/16″, but shows significant widening at the center. Such a material distribution is unsuitable for the score repair application described above because of the large deviation from the desired circular pattern.

FIG. 5 shows a spray pattern 82 formed using a nozzle 20 having a three orifice nozzle tip 10 in accordance with the present invention. The flow rate of this nozzle 20 was about 0.03 gallons per minute. The spray pattern 82 has a width of about one and one-eighth inches at one inch from the nozzle tip 10. As shown in FIG. 5, the spray pattern 82 is significantly better than the spray pattern 80 shown in FIG. 4. This spray pattern 82 shows a distribution which is acceptable for most applications requiring a circular spray pattern at a low flow rate.

FIG. 6 shows another spray pattern 84 formed using another three orifice nozzle tip 10 in accordance with the present invention, with different orifice dimensions. The flow rate of this nozzle tip 10 was about 0.03 gallons per minute. The spray pattern 84 has a width of about 15/16 of an inch at one inch from the nozzle tip 10. As shown in FIG. 6, the spray pattern 84 is significantly better than the spray pattern 80 shown in FIG. 4.

FIG. 7 shows a spray pattern 86 formed using another three orifice nozzle tip 10 in accordance with the present invention, with different orifice dimensions. The flow rate of this nozzle tip 10 was about 0.045 gallons per minute. The spray pattern has a width of about one inch at 10 inches from the nozzle tip 10. As shown in FIG. 7, the spray pattern 86 is significantly better than the spray pattern 80 shown in FIG. 4. This spray pattern 86 shows a good even distribution which is acceptable for most applications requiring a circular spray pattern at a low flow rate.

FIG. 8 shows a spray pattern 88 formed using another three orifice nozzle tip 10 in accordance with the present invention, with different orifice dimensions. The flow rate of this nozzle tip 10 was about 0.045 gallons per minute. The spray pattern has a width of about one inch at one inch from the nozzle tip 10. As shown in FIG. 7, the spray pattern 88 is significantly better than the spray pattern 80 shown in FIG. 4. This spray pattern 88 shows a good even distribution which is acceptable for most applications requiring a circular spray pattern at a low flow rate.

1-5. (canceled)

6. A process of coating a workpiece with liquid sprayed from a nozzle, said process including the steps of: directing the liquid at the workpiece through a nozzle tip in the nozzle; and producing a generally circular pattern with a diameter about one half inch or greater, at a distance in the range of from about one inch to about three inches from the nozzle tip, and at a flow rate below about 0.045 gallons per minute.

7. A process as set forth in claim 6 wherein said directing step comprises directing the liquid through three orifices in the nozzle tip.

8. A process as set forth in claim 6 wherein said directing step comprises directing the liquid through three orifices that are collinear and that are formed by penetrating a first groove on a first side of the nozzle tip with three grooves on a second side of the nozzle tip.

9. A process as set forth in claim 8 wherein the first side of the nozzle tip is a pressurized side or back side of the nozzle tip, and the second side of the nozzle tip is an unpressurized side of the nozzle tip.

10. A process as set forth in claim 9 wherein the first groove is a wedge-shaped groove through which the liquid is directed into the three orifices.

11. A process as set forth in claim 6 wherein the flow rate is in the range of from about 0.01 gallons per minute to about 0.045 gallons per minute.

12. A process of coating a portion of a container with liquid sprayed from a nozzle, said process including the steps of: directing the liquid at the container through a nozzle tip in the nozzle; and producing a generally circular pattern with a diameter about one half inch or greater, at a distance in the range of from about one inch to about three inches from the nozzle tip, and at a flow rate below about 0.045 gallons per minute.

13. A process as set forth in claim 12 wherein said directing step comprises directing the liquid at a pull tab portion of the container.

14. A process as set forth in claim 13 wherein said directing step comprises directing the liquid at a rivet of the pull tab portion of the container.

15-16. (canceled)

17. A process of coating a workpiece with liquid sprayed from a nozzle, said process including the steps of: directing the liquid with a low flow rate toward the workpiece through three orifices in a nozzle tip of the nozzle; with the spray patterns from said orifices combining and producing a generally circular spray pattern of the liquid on the workpiece.

18. The process of claim 17 wherein said low flow rate is about 0.045 gallons per minute or less.

19. The process of claim 18 wherein flow rate through the nozzle tip, of water at a pressure of 500 psi, is in the range of about 0.01 gallons per minute to about 0.045 gallons per minute.

20. The process of claim 17 wherein said generally circular pattern is about one-half inch in diameter when liquid is sprayed at a distance from the workpiece of about one inch to about three inches, at a flow rate of about 0.045 gallons per minute or less.
